(19) United States
(12) Patent Application Publication
(10) Pub. No.: US 2024/0193786 A1
(43) Pub. Date: Jun. 13, 2024

(54) METHOD AND SYSTEM FOR RECONGIZING SPACE

(71) Applicants: HYUNDAI MOTOR COMPANY, Seoul (KR); KIA CORPORATION, Seoul (KR)

(72) Inventor: Kyeon Ji Kim, Seoul (KR)

(73) Assignees: HYUNDAI MOTOR COMPANY, Seoul (KR); KIA CORPORATION, Seoul (KR)

(21) Appl. No.: 18/516,773

(22) Filed: Nov. 21, 2023

(30) Foreign Application Priority Data
Dec. 8, 2022 (KR) 10-2022-0170425

(51) Int. Cl. G06T 7/13; G06T 7/73

(52) U.S. Cl. CPC G06T 7/13; G06T 7/73; G06T 2207/10028; G06T 2207/20164; G06T 2207/30264

(57) ABSTRACT

According to an embodiment of the present disclosure, a method for recognizing a free-space around a vehicle comprises determining a corner point from cluster points of an object based on a line segment connecting a first point and a second point of the cluster points obtained by clustering Light Detection and Ranging (LiDAR) points, determining a segment parameter according to a distance between the line segment and the corner point based on cluster points located at both sides of the corner point, and generating an L-shaped contour of the object based on the segment parameter to output spatial information including contour information.

### CROSS-REFERENCE TO RELATED APPLICATION

The present application claims the benefit of priority to Korean Patent Application No. 10-2022-0170425, filed on Dec. 8, 2022 in the Korean Intellectual Property Office, the entire contents of which is incorporated herein by reference.

### TECHNICAL FIELD

The present disclosure relates to a method and system for recognizing space.

### BACKGROUND

Technologies of autonomous parking control as well as autonomous driving control for vehicles have been developed.

Conventionally, an autonomous parking control technology for a vehicle has been developed with an assumption that an object protruding in the direction toward the vehicle is present.

For example, under such an assumption, a technology for acquiring contour information of the object to recognize a surrounding space of the vehicle and control autonomous parking of the vehicle based on the contour information has been developed.

However, there has been a problem in that contour information of an object located around a vehicle is not accurately recognized in an environment having a different situation from the situation with the above assumption.

Accordingly, in the conventional autonomous parking control technology, the surrounding space of the vehicle, for example, a parking space, is recognized based on inaccurate contour information of an object, thereby deteriorating space recognition performance and parking control performance of the vehicle.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to a method and system for recognizing a space capable of improving the performance of recognizing a surrounding space of a vehicle, for example, a parking space, by conservatively extracting contours of surrounding objects of the vehicle in various situations.

According to an exemplary embodiment of the present disclosure, a method for recognizing a free-space around a vehicle comprises determining a corner point from cluster points of an object based on a line segment connecting a first point and a second point of the cluster points obtained by clustering Light Detection and Ranging (LiDAR) points, determining a segment parameter according to a distance between the line segment and the corner point based on cluster points located at both sides of the corner point, and generating an L-shaped contour of the object based on the segment parameter to output spatial information including contour information.

In at least one exemplary embodiment of the present disclosure, the clustering of LiDAR points includes identifying closest points which are closest to the vehicle among the LiDAR points at respective predetermined angular intervals, identifying region of interest (ROI) points closest points which are located within a predetermined ROI among the closest points, determining points within a predetermined threshold distance from each other among the ROI points as the cluster points ROI points.

In at least one exemplary embodiment of the present disclosure, the identifying of the closest points is performed based on dividing a space in front of the vehicle into a plurality of cells by the predetermined angular interval.

In at least one exemplary embodiment of the present disclosure, the determining of the points within the predetermined threshold distance includes removing outliers from the points within the predetermined threshold distance.

In at least one exemplary embodiment of the present disclosure, the determining of the corner point includes determining a point having a maximum distance from the line segment among the cluster points as the corner point.

In at least one exemplary embodiment of the present disclosure, the determining of the segment parameter is performed when the distance between the segment and the corner point is greater than a predetermined threshold distance.

In at least one exemplary embodiment of the present disclosure, the determining of the segment parameter includes dividing the cluster points into two clusters each located at one of both sides of the corner point, and determining the segment parameter through a singular value decomposition based on coordinate values of the cluster points divided into the two clusters.

In at least one exemplary embodiment of the present disclosure, the generating of the L-shaped contour of the object includes generating a first segment and a second segment of the L-shaped contour based on the segment parameter.

In at least one exemplary embodiment of the present disclosure, the contour information includes position information of the first point, position information of the second point, the segment parameter, and position information of the corner point.

In at least one exemplary embodiment of the present disclosure, the method further comprises generating an L-shaped contour based on maximum and minimum coordinate values of X-axis and maximum and minimum coordinate values of Y-axis among the cluster points when the distance between the segment and the corner point is equal to or smaller than the predetermined threshold distance.

A free-space recognizing system, according to an exemplary embodiment of the present disclosure, comprises an interface configured to obtain LiDAR points from a Light Detection and Ranging (LiDAR) sensor, and a processor connected to the interface electrically or communicatively, wherein the processor is configure to perform determining a corner point from cluster points of an object based on a segment connecting a first point and a second point among the cluster points obtained by clustering the LiDAR points, determining a segment parameter according to a distance between the segment and the corner point based on cluster points located at both sides of the corner point, and generating an L-shaped contour of the object based on the segment parameter to output spatial information including contour information.

In at least one exemplary embodiment of the system of the present disclosure, the processor is further configured to perform identifying closest points which are closest to the vehicle at respective predetermined angular intervals among the LiDAR points, identifying ROI points in an ROI among the closest points, and determining points within a predetermined threshold distance among the ROI points as the cluster points based on distances between the ROI points.

In at least one exemplary embodiment of the system of the present disclosure, the processor is further configured to perform identifying closest points based on dividing a space in front of the vehicle into a plurality of cells by the predetermined angular interval.

In at least one exemplary embodiment of the system of the present disclosure, the processor is further configured to perform removing outliers from the points within the predetermined threshold distance.

In at least one exemplary embodiment of the system of the present disclosure, the processor is further configured to perform determining a point having a maximum distance from the segment among the cluster points as the corner point.

In at least one exemplary embodiment of the system of the present disclosure, the processor is further configured to perform determining the segment parameter when the distance between the segment and the corner point is greater than a predetermined threshold distance.

In at least one exemplary embodiment of the system of the present disclosure, the processor is further configured to perform dividing the cluster points into two clusters each located at one of both sides of the corner point and determining the segment parameter through a singular value decomposition based on coordinate values of the cluster points divided into the two clusters.

In at least one exemplary embodiment of the system of the present disclosure, the processor is configured to perform generating a first segment and a second segment of the L-shaped contour based on the segment parameter.

In at least one exemplary embodiment of the system of the present disclosure, the contour information includes position information of the first point, position information of the second point, the segment parameter, and position information of the corner point of the L-shaped contour.

In at least one exemplary embodiment of the system of the present disclosure, the processor is further configured to perform generating an L-shaped contour based on maximum and minimum coordinate values of X-axis and maximum and minimum coordinate values of Y-axis among the cluster points when the distance between the segment and the corner point is equal to or less than the predetermined threshold distance.

The method and system for recognizing space according to an exemplary embodiment of the present disclosure may provide accurate information required for searching a free-space, e.g., a parking space and/or parking control (also referred to as autonomous parking control) of a vehicle by conservatively forming and outputting the L-shaped contour for various objects or scenarios.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF DRAWINGS

FIG. 1A is a block diagram of a vehicle according to an exemplary embodiment of the present disclosure.

FIG. 1B is a diagram illustrating a detailed feature of a processor of a system for recognizing space according to an exemplary embodiment of the present disclosure.

FIG. 2 is a flowchart of an operation of a system for recognizing space according to an exemplary embodiment of the present disclosure.

FIG. 3 is a flowchart of a clustering operation of free-space points of the system for recognizing space according to the exemplary embodiment of FIG. 2.

FIG. 4 is a flowchart of an L-fitting operation of a system for recognizing space according to the exemplary embodiment of FIG. 2.

FIG. 5 and FIGS. 6A and 6B illustrate an L-fitting operation of a system for recognizing space according to an exemplary embodiment of the present disclosure.

FIGS. 7A, 7B, 7C, 7D and 7E and FIGS. 8A, 8B, 8C, 8D and 8E are views for explaining an L-shaped contoured generated according to a conventional technology and an exemplary embodiment of the present disclosure.

FIGS. 9A, 9B and 9C are images illustrating examples of various spatial information around a vehicle.

FIG. 10 is a diagram for describing an output power of related information according to an operation of a system for recognizing space according to an exemplary embodiment of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent parts of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Like reference numerals refer to like elements throughout the specification. The present specification does not describe all elements of the embodiments, and general contents in the technical field to which the present disclosure pertains or overlaps contents between the embodiments are omitted. The term “unit”, “module”, or “device” used in the specification may be implemented by software or hardware, and according to embodiments, a plurality of “units”, “modules”, or “devices” may be implemented as one element, or one “unit”, “module”, or “device” may include the plurality of elements.

Throughout the specification, when a part is “connected” to another part, this includes not only a case of being directly connected but also a case of being indirectly connected, and the indirect connection includes being connected through a wireless communication network.

In addition, when a part “includes” an element, this means that other elements may be further included, rather than excluding other elements, unless specifically stated otherwise.

The terms “first”, “second”, etc. are used to distinguish one element from another element, and the elements are not limited by the above terms.

A singular expression includes a plural expression unless there is a clear exception in the context.

In each step, the identification code is used for convenience of description, and the identification code does not describe the order of each step, and each step may be performed differently from the stated order unless a specific order is clearly described in the context.

When controlling a vehicle, for example, autonomous parking control, corner points of objects around a parking space and contour information surrounding the object may be used to search for and control parking of the parking space. Accordingly, in an exemplary embodiment of the present disclosure, a technology capable of deriving a result of fitting LiDAR points into an L shape in order to obtain corner points and contour information of an object may be provided.

Hereinafter, operation principles and various embodiments of the present disclosure will be described with reference to the accompanying drawings.

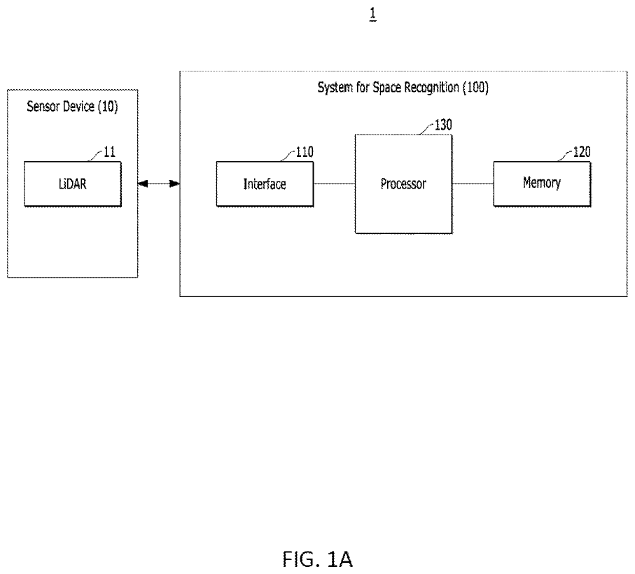

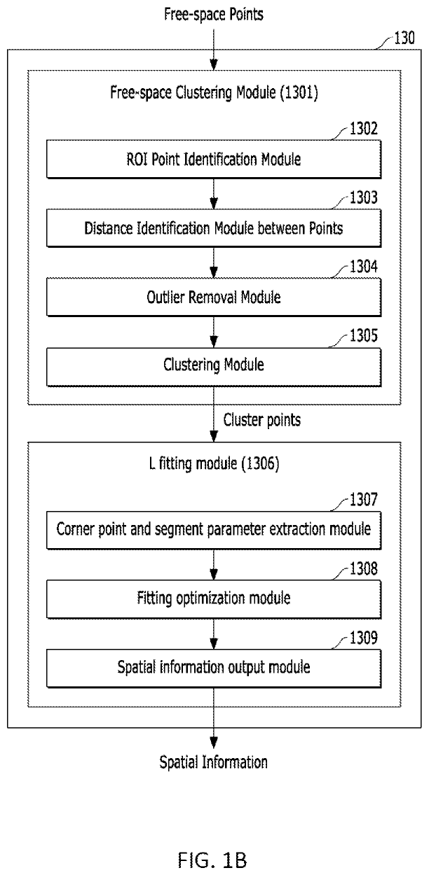

FIG. 1(a) is a block diagram of a vehicle according to an exemplary embodiment of the present disclosure, and FIG. 1(b) is a diagram illustrating detailed feature of a processor of a system for recognizing space according to an exemplary embodiment of the present disclosure.

Referring to FIG. 1(a), a vehicle 1 may include a sensor device 10 and a system 100 for recognizing space.

The sensing device 10 may include one or more devices capable of acquiring information about an object (also referred to as a target) located around the vehicle 1.

The sensor device 10 may include a Light Detection and Ranging (LiDAR) sensor 11 (hereinafter, simply referred to as a LiDAR 11).

The LiDAR 11 may be one or a plurality, and may be mounted in the vehicle 1 to generate LiDAR data, i.e., a plurality of point data (also referred to as point cloud data) by emitting a laser pulse toward the periphery of the vehicle 1.

Meanwhile, although not shown, the sensor device 10 may further include a radar (not shown) capable of sensing objects around the vehicle 1 and/or a camera (not shown) capable of obtaining image data around the vehicle 1.

The system 100 for recognizing space may include an interface 110, a memory 120, and/or a processor 130.

The interface 110 may transmit commands or data input from another device (i.e., the sensing device 10 and/or a vehicle control device (not shown)) of the vehicle 1 or a user to another feature element of the system 100 for recognizing space, or may output commands or data received from another element of the system 100 for recognizing space to another device of the vehicle 1.

The interface 110 may include a communication module (not shown) to communicate with other devices of the vehicle 1.

The communication module of the interface 110 may be a hardware device implemented by various electronic circuits, e.g., processor, transceiver, etc., to transmit and receive signals via wireless or wired connections. For example, the communication module may include a communication module capable of performing communication between devices of the vehicle 1, for example, controller area network (CAN) communication and/or local interconnect network (LIN) communication, through a vehicle communication network. Further, the communication module may be a wired communication module (i.e., a power line communication module) and/or a wireless communication module (i.e., a cellular communication module, a Wi-Fi communication module, a short-range wireless communication module, and/or a global navigation satellite system (GNSS) communication module) can be included.

The memory 120 may store various data used by at least one feature element of the system 100 for recognizing space, for example, input data and/or output data for a software program and commands related thereto.

The memory 120 may include a nonvolatile memory such as a cache, a Read Only Memory (ROM), a Programmable ROM (PROM), an Erasable Programmable ROM (EPROM), an Electrically Erasable Programmable ROM (EEPROM), and/or a flash memory, and/or a volatile memory such as a Random Access Memory (RAM).

The processor 130 (also referred to as a control circuit or a controller) (e.g., computer, microprocessor, CPU, ASIC, circuitry, logic circuits, etc.) may control at least one other feature element (i.e., a hardware feature element (i.e., the interface 110 and/or the memory 120) and/or a software feature element (a software program)) of the system 100 for recognizing space and may perform various data processing and operations.

The processor 130 may perform clustering LiDAR points acquired through the LiDAR 11 by a predetermined clustering method which may be one of well-known methods in the art.

The processor 130 may determine a corner point of the object from the cluster points based on a line segment connecting a first point (also referred to as a start point) and a second point (also referred to as an end point) among the cluster points.

The processor 130 may generate an L-shaped contour of the object by applying one of two predetermined methods according to the distance between the segment and the corner point, and output spatial information including information related to the generated contour.

When the distance between the segment and the corner point is greater than a predetermined threshold distance, the processor 130 may determine the segment parameter based on the cluster points located on both sides of the corner point. The processor 130 may generate the L-shaped contour of the object based on the line segment parameter and output spatial information including contour information.

When the distance between the segment and the corner point is equal to or less than the predetermined threshold distance, the processor 130 may generate the L-shaped contour based on the maximum coordinate value and the minimum coordinate value of X-axis and the maximum coordinate value and the minimum coordinate value of Y-axis for the cluster points, and output spatial information including contour information. The X-axis may be an axis along a longitudinal direction of the vehicle, the Y-axis may be an axis along a lateral direction of the vehicle.

Referring to FIG. 1b, the processor 130 may include a free-space clustering module 1301 and an L-fitting module 1306.

The free-space clustering module 1301 may include the region of interest (ROI) point identification module 1302, a distance identification module 1303 between points, an outlier removal module 1304, and/or a clustering module 1305.

The ROI point identification module 1302 may receive free-space points, which are points of a position closest to the vehicle 1 (or X and Y-left tables) at each predetermined angle interval among the LiDAR points obtained from the LiDAR 12. The ROI point identification module 1302 may identify points within a predetermined ROI among free-space points.

The distance identification module 1303 may identify whether the distance between the points in the ROI is within the predetermined threshold distance. The distance identification module 1303 may assign a cluster index to points within the predetermined threshold distance.

The outlier removal module 1304 may perform outlier removal for removing noise points among points assigned with the cluster index.

The clustering module 1305 may perform clustering outlier-removed points by identifying the cluster index of the outlier-removed points, and may output respective indexes of the cluster points and the cluster points.

L-fitting module 1306 can include a corner point and segment parameter extraction module 1307, a fitting optimization module 1308, and/or a spatial information output module 1309.

The corner point and segment parameter extraction module 1307 may determine as the corner point a point having a greatest distance from the segment connecting the start point and the end point.

The corner point and segment parameter extraction module 1307 may determine the segment parameter as having the smallest error from the cluster points based on both side cluster points with respect to the corner point.

The fitting optimization module 1308 may perform fitting optimization so as to be L-fitting, and the corner point may be modified according to the fitting optimization.

The spatial information output module 1309 may output spatial information, for example, information on corner points corresponding to parking spatial information of the vehicle 1, both end points among the cluster points, and line segment parameters.

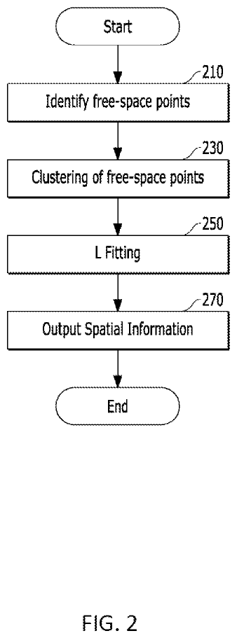

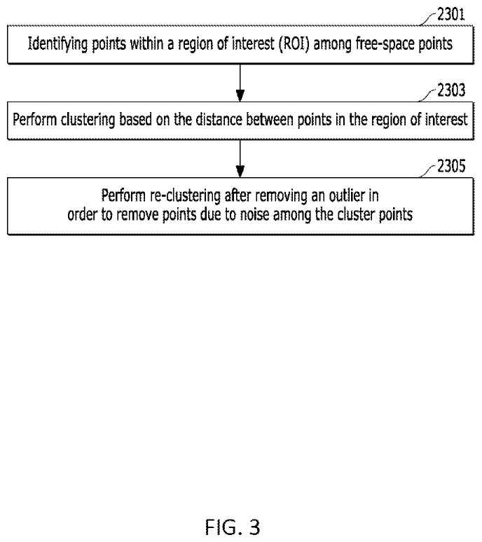

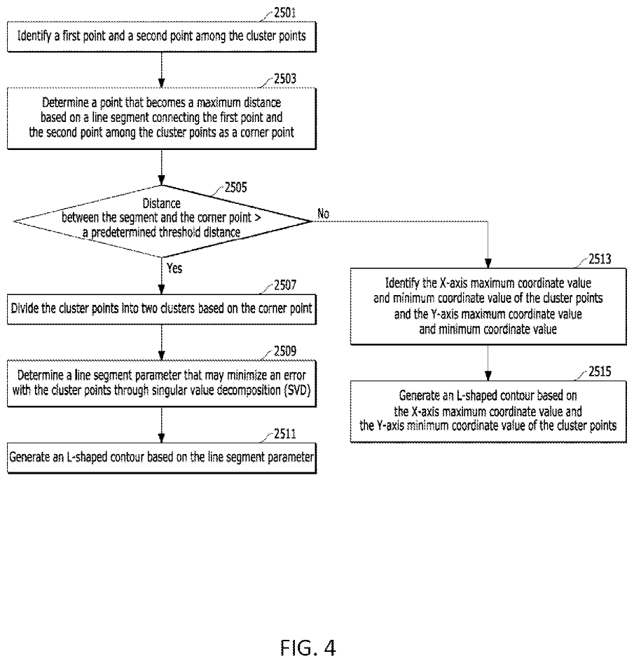

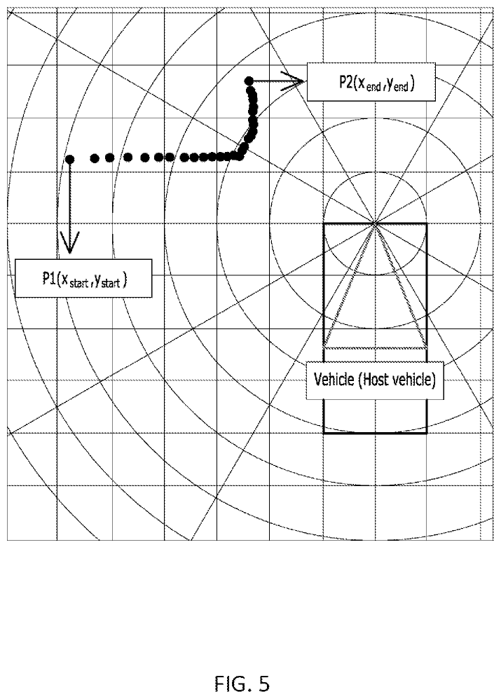

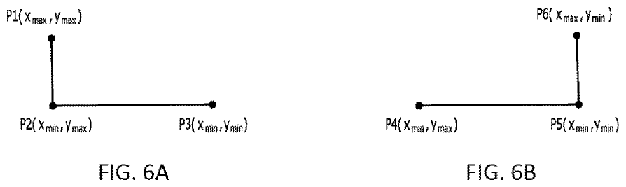

FIG. 2 is a flowchart of an operation of the system 100 for recognizing space (and/or the processor 130) according to one exemplary embodiment. FIG. 3 is a flowchart of a clustering operation of free-space points of the system 100 for recognizing space (and/or the processor 130) in accordance with the exemplary embodiment of FIG. 2. FIG. 4 is a flowchart of an L-fitting operation of the system 100 for recognizing space (and/or the processor 130) according to the exemplary embodiment of FIG. 2. FIGS. 5 and 6 are drawings for explaining an L-fitting operation of the system 100 for recognizing space (and/or the processor 130) according to an exemplary embodiment.

Referring to FIG. 2, the system 100 for recognizing space may identify free-space points from the LiDAR points obtained from the LiDAR 11 (210).

The system 100 for recognizing space may divide a coordinate space corresponding to the front of the vehicle 1 into the plurality of cells having a predetermined angular interval, and identify points at the position closest to the vehicle 1 (or X and Y coordinates) at the predetermined angular intervals among the LiDAR points.

For example, the predetermined angular interval may be an interval of 1 degree, and accordingly, the number of the plurality of cells may be 180.

The system 100 for recognizing space may perform clustering of free-space points based on the free-space points (230).

For example, the system 100 for recognizing space may perform clustering of free-space points through operations such as those of FIG. 3.

Referring to FIG. 3, the system 100 for recognizing space may identify points within a region of interest (ROI) among free-space points (2301).

The system 100 for recognizing space may perform clustering based on the distance between points in the region of interest (2303).

For example, the system 100 for recognizing space may determine points within the predetermined threshold distance among points within the region of interest as the cluster points of one object. Further, the system 100 for recognizing space may determine the cluster points of each object by dividing points, which are out of the predetermined threshold distance among the points within the region of interest, into points of different objects.

The system 100 for recognizing space may perform re-clustering after removing the outlier in order to remove points due to noise among the cluster points (2305).

The system 100 for recognizing space may perform L fitting (250).

For example, the system 100 for recognizing space may perform L fitting that generates the L-shaped contour of an object through operations such as those illustrated in FIG. 4.

Referring to FIG. 4, the system 100 for recognizing space may identify the first point and the second point among the cluster points (2501).

Referring to FIG. 5, the system 100 for recognizing space may differentiate the first point P1 corresponding to the start point based on the vehicle 1 (also referred to as a vehicle coordinate system) and the second point P2 corresponding to the end point based on the vehicle 1 from among the plurality of cluster points.

The system 100 for recognizing space may determine a point that becomes the maximum distance based on the line segment connecting the first point and the second point among the cluster points as the corner point (2503).

The system 100 for recognizing space may determine an equation of the line segment connecting the first point P1 and the second point P2 based on the coordinate values xₛₜₐᵣₜ and yₛₜₐᵣₜ of the first point P1 and the coordinate values x_{end} and y_{end} of the second point P2 as follows.

Equation of line segment connecting first point P1 and second point P2:

axᵢ+byᵢ+c=0
where a=y_{end}−yₛₜₐᵣₜ, b=−(x_{end}−xₛₜₐᵣₜ), c=a×xₛₜₐᵣₜ−b×yₛₜₐᵣₜ, and i denotes an index of each of cluster points.

The system 100 for recognizing space may determine the distance between the line segment connecting the first point P1 and the second point P2 and each of the cluster points through Equation 1 below.

$${dist}_{i} = \frac{( - {by}_{i} - c ) - {ax}_{i}}{\sqrt{{a}^{2} + {b}^{2}}} \qquad Equation 1$$

where distᵢ denotes a distance between the cluster point of index i and the line segment, a, b, c, xᵢ, and yᵢ denote a, b, c, xᵢ, and yᵢ in the equation of the line segment).

The system 100 for recognizing space may identify a point that is the maximum distance from the line segment and determine the point as the corner point, according to the determination of the distance between the line segment connecting the first point P1 and the second point P2 and each of the cluster points.

The system 100 for recognizing space may determine whether the distance between the segment and the corner point is greater than the predetermined threshold distance (2505).

The system 100 for recognizing space may perform operation 2507 when the distance between the segment and the corner point is greater than the predetermined threshold distance, and perform operation 2513 otherwise.

The system for recognizing a space 100 may divide the cluster points into two clusters based on the corner points (2507).

For example, when the corner point is i*, the system for recognizing a space 100 may divide the cluster points into the first cluster and the second cluster according to the following conditions.

### Conditions:

first cluster={(xᵢ,yᵢ)|i≤i*}

second cluster={(xᵢ,yᵢ)|i≥i*}
where xᵢ and yᵢ denote xᵢ, and yᵢ in the equation of the line segment.

The system 100 for recognizing space may determine the line segment parameter that may minimize an error with the cluster points through singular value decomposition (SVD) (2509).

Since the first segment and the second segment constituting the L-shaped contour are orthogonal to each other, the first segment and the second segment may be represented by the following equation of a straight line.

Equation of straight line of first line segment and second line segment:

l₁:ax+by+c=0

l₂:bₓ−ay+d=0.

where l₁ denotes Equation of straight line of the first segment and l₂ denotes Equation of a straight line of the second segment.

When the total number of cluster points arranged in the L shape is N and the cluster points index is expressed as n, cluster points having indexes from 1 to n should satisfy l1 and cluster points having indexes from n to N should satisfy l₂. This can be expressed in linear algebraic form as Equation 2 below.

$${\underbrace{[ \begin{matrix}{x}_{1} & {y}_{1} & 1 & 0 \\ ⋮ & & & \\ {x}_{n} & {y}_{n} & 1 & 0 \\ - {y}_{n} & {x}_{n} & 0 & 1 \\ ⋮ & & & \\ - {y}_{N} & {x}_{N} & 0 & 1\end{matrix} ]}}_{{A}_{n}} \cdot {\underbrace{[ \begin{matrix}a \\ b \\ c \\ d\end{matrix} ]}}_{{X}_{n}} = 0 \qquad Equation 2$$

where Aₙ denotes the measurement value matrix and Xₙ denotes the segment parameter matrix when the cluster points index is n, which is a null vector of a specific value matrix.

Therefore, in an exemplary embodiment of the present disclosure, the segment parameter matrix Xₙ satisfying Equation 2 may be found, and the segment parameter of the equation l₁ of the first segment and the equation l₂ of the second segment may be estimated.

For example, the line segment parameter matrix Xₙ corresponding to the null vector of Aₙ may be found using an SVD such as Equation 3 below, and the line segment parameter of an equation l1 of the first line segment and an equation l2 of the second line segment may be estimated.

[Uₙ,Sₙ,Vₙ=]=SVD(Aₙ) Equation 3:

where Uₙ denotes an output base matrix when an index of the cluster points is n, Sₙ denotes an singular value matrix, and Vₙ denotes an input base matrix.

The system 100 for recognizing space may generate the L-shaped contour based on the line segment parameter (2511).

The system 100 for recognizing space may generate the L-shaped contour including the first line segment and the second line segment by determining linear equations l₁ and l₂ of the first line segment and the second line segment based on the line segment parameter.

When the distance between the segment and the corner point is equal to or less than the predetermined threshold distance, the system 100 for recognizing space may identify the X-axis maximum coordinate value and the minimum coordinate value of the cluster points and the Y-axis maximum coordinate value and the minimum coordinate value (2513).

The system 100 for recognizing space may generate the L-shaped contour based on the X-axis maximum coordinate value and the Y-axis minimum coordinate value of the cluster points (2515).

For example, the system 100 for recognizing space may generate the L-shaped contour including all the cluster points based on the X-axis maximum coordinate value and the Y-axis minimum coordinate value of the cluster points and the X-axis maximum coordinate value and the Y-axis minimum coordinate value of the cluster points.

Referring to FIG. 6, when the X-axis maximum coordinate value of the cluster points is xₘₐₓ, the X-axis minimum coordinate value of the cluster points is xₘᵢₙ, the Y-axis maximum coordinate value of the cluster points is yₘₐₓ, and the Y-axis minimum coordinate value of the cluster points is yₘᵢₙ, the L-shaped contour may be generated by connecting three points as shown in FIG. 6(a) or FIG. 6(b).

Referring to FIG. 6(a), when the object is located on the right side with respect to the vehicle 1, the system 100 for recognizing space may generate the L-shaped contour by connecting P1(xₘₐₓ, yₘₐₓ), P2(xₘᵢₙ, yₘᵢₙ), and P3(xₘᵢₙ, yₘᵢₙ).

Referring to of FIG. 6(b), when the object is located on the left side with respect to the vehicle 1, the system 100 for recognizing space may generate an L-shaped contour by connecting P4(xₘᵢₙ, yₘₐₓ), P5(xₘᵢₙ, yₘᵢₙ), and P6(xₘₐₓ, yₘᵢₙ).

Referring back to FIG. 2, the system 100 for recognizing space may output spatial information including contour information of the L-shaped contour (270).

For example, the contour information may include position information of the corner point, position information of the first point and the second point corresponding to both end points of the cluster, and the line parameter.

For example, when the L-shaped contour is generated based on the determination of the line segment parameter through the SVD, the position information of the corner point may be position information of the corner point changed based on the determination of the line segment parameter through the SVD, not the position information of the corner point determined in operation 2503.

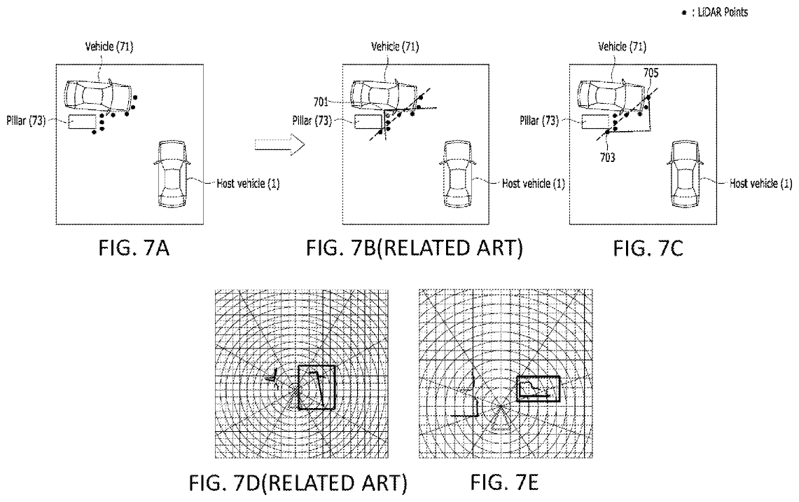

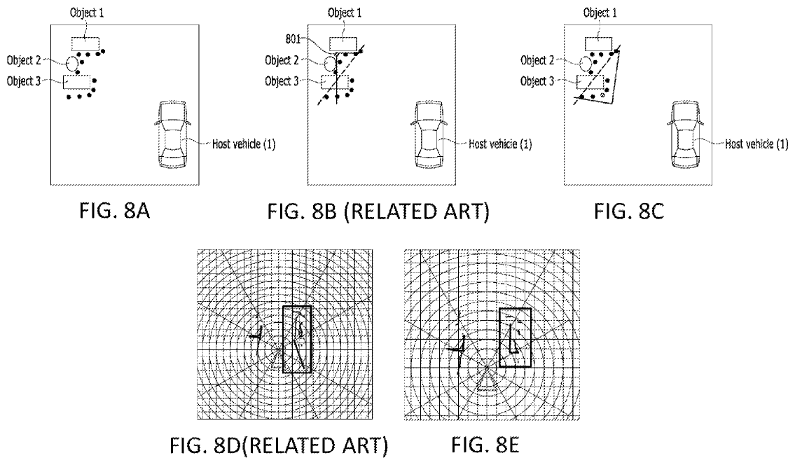

FIGS. 7 and 8 are views for explaining the L-shaped contour generated in a conventional manner and according an exemplary embodiment of the present disclosure.

Referring to FIG. 7, when a specific vehicle 71 and a pillar 73 are adjacent to each other as illustrated in FIG. 7(a), LiDAR points may be formed according to the vehicle 71 and the pillar 73.

In a conventional case, as shown in FIG. 7(b), point 701 that is positioned inside where the unintended vehicle 71 and a pillar 73 meet is selected from the LiDAR points Therefore, there has been a problem of outputting the unintended L-shaped contour as shown in FIG. 7(d) by performing L-fitting.

However, according to the above-described embodiment of the present disclosure, the point located on the inner side where the vehicle 71 and the pillar 73 are in contact with each other may generate and output the L-shaped contour as shown in FIG. 7(e) based on the maximum coordinate value and the minimum coordinate value of the X-axis and the maximum coordinate value and the minimum coordinate value of the Y-axis of the cluster points without affecting the L-fitting.

Referring to FIG. 8, when several objects (object 1, object 2, and object 3) are positioned adjacent to each other as shown in FIG. 8(a), the LiDAR points may be formed in a sparse form without being separated from each other.

In a conventional case, as shown in FIG. 8(b), the L-fitting is performed by selecting the point 801 located at the inner side of the LiDAR points, thereby outputting the unintended contour as shown in FIG. 8(d).

However, according to the above-described embodiment of the present disclosure, the point positioned at the inside may generate and output the L-shaped contour as shown in FIGS. 8(c) and 8(e) based on the X-axis maximum coordinate value and minimum coordinate value of the cluster points and the Y-axis maximum coordinate value and minimum coordinate value without affecting the L-fitting.

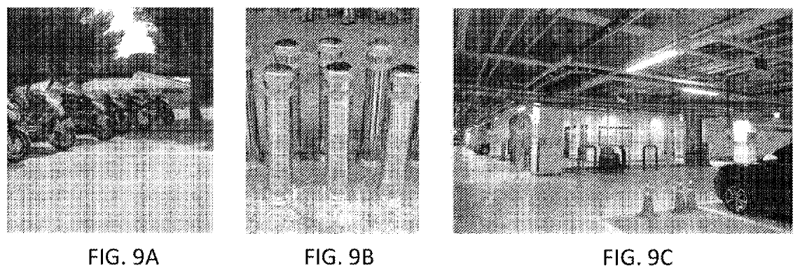

FIGS. 9(a), (b), and (c) are images illustrating examples of various spatial information around a vehicle.

When motorcycles are parked as shown in FIG. 9(a), thin pillars are formed as shown in FIG. 9(b), or a person is present, the LIDAR 11 of the vehicle 1 is used. The obtained LiDAR point may be sparsely obtained without a sufficient number or may be obtained in a concave arrangement rather than an L shape.

In addition, in the case where there is a glass door as shown in FIG. 9(c), the LiDAR point may be obtained sparsely including both objects inside and outside the glass door.

In the cases of FIG. 9(a), FIG. 9(b), and FIG. 9(c), it is necessary to provide information for identifying that the vehicle 1 cannot enter according to the corresponding objects to the control device of the vehicle 1, and the control device of the vehicle 1 may perform control to prevent collision with the object of the vehicle 1 together with whether the vehicle 1 can enter through the information output through the above-described embodiment.

For example, according to the above-described embodiment, the system 100 for recognizing space may conservatively generate an L-shaped contour including all objects and output related information, and the control device of the vehicle 1 may prevent collision with the object of the vehicle 1 based on the information output from the system 100 for recognizing space.

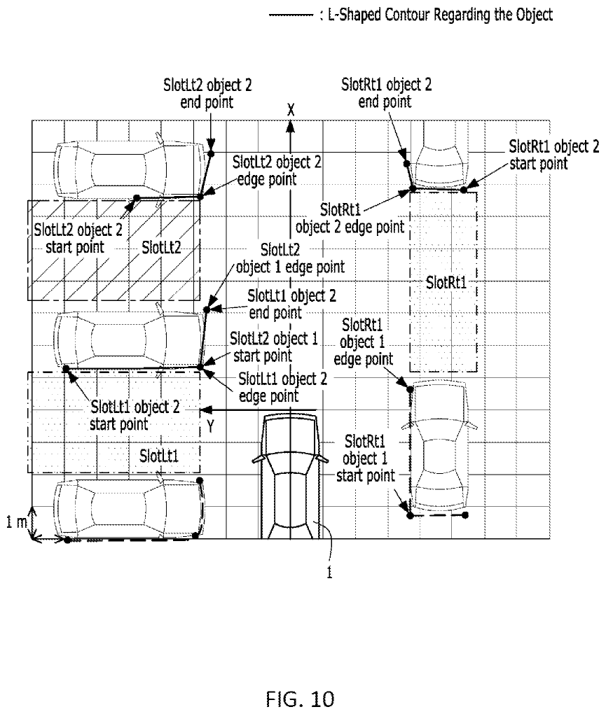

For example, the system 100 for recognizing space may form an L-shaped contour for each of the plurality of objects as shown in FIG. 10 and output related information to the control device of the vehicle 1.

FIG. 10 is a drawing for describing an output of related information according to an operation of the system 100 for recognizing space according to an exemplary embodiment.

Referring to FIG. 10, the system 100 for recognizing space may generate and output an L-shaped contour for each of objects located in the surrounding of the vehicle 1.

In addition, the system 100 for recognizing space may output the spatial information of the object based on the first slot (SlotLt1) on the left side of the vehicle 1. For example, the spatial information of the object based on the first slot (SlotLt1) on the left side of the vehicle 1 may include position information of a start point (SlotLt1 object2 start point) of object2 of the first slot on the left side, an edge point (SlotLt1 object2 edge point) of object2 of the second slot on the left side, and an end point (SlotLt1 object2 end point) of object2 of the second slot on the left side.

In addition, the system 100 for recognizing space may output the spatial information of the object based on the second slot (SlotLt2) on the left side of the vehicle 1. For example, the spatial information of the object based on the second slot (SlotLt2) on the left side of the vehicle 1 may include location information of a start point (SlotLt2 object1 start point) of object1 of the second slot on the left side, an edge point (SlotLt2 object1 edge point) of object1 of the second slot on the left side, and an end point (SlotLt2 object1 end point) of object1 of the second slot on the left side. In addition, the spatial information of the object based on the second slot (SlotLt2) on the left side of the vehicle 1 may include position information of the start point (SlotLt2 object2 start point) of object2 of the second slot on the left side, the edge point (SlotLt2 object2 edge point) of object2 of the second slot on the left side, and the end point (SlotLt2 object2 end point) of object2 of the second slot on the left side.

In addition, the system 100 for recognizing space may output the spatial information of the object based on the first slot (SlotLt1) on the right side of the vehicle 1. For example, the spatial information of the object based on the first slot (SlotLt1) on the right side of the vehicle 1 may include position information of the start point (SlotLt1 object1 starting point) of object1 of the first slot on the right side and the corner point (SlotLt1 object1 corner point) of object1 of the first slot on the right side. In addition, the spatial information of the object based on the first slot (SlotLt1) on the right side of the vehicle 1 may include position information of the start point (SlotLt1 object 2 start point) of object 2 of the first slot on the right side, the edge point (SlotLt1 object 2 edge point) of object 2 of the first slot on the right side, and the end point (SlotLt1 object 2 end point) of object 2 of the first slot on the right side.

Meanwhile, the positions of the start point, the corner point, and the end point of the L-shaped contour of each object may be determined and/or changed based on the position of the vehicle 1, as shown in FIG. 10.

According to the above-described embodiment, unlike the conventional case in which the L-shaped contour is generated by assuming only the L-shaped object protruding in the direction of the vehicle, the L-shaped contour may be generated and output without assuming the shape of the LiDAR points.

For example, in the conventional case, when corner points are extracted, the corner points are selected based solely on an absolute distance between points and a line connecting the start point and the end point of the cluster points.

Accordingly, when corner points are determined from cluster points arranged in a concave shape or a sparse shape, unintended points are extracted as corner points, and the contour having the L-shape that digs into a space in which the L-shaped object or a space in which all cluster points are not enclosed is generated and output.

On the other hand, when extracting the corner points, the system for recognizing a space 100 according to the above-described embodiment may determine the corner points on the basis of the difference between the line segment connecting the start point and the end point of the cluster points and the cluster points. In this case, when the point is located far from the vehicle 1, that is, in the direction of the host vehicle, the difference value may be a negative number. In addition, the system 100 for recognizing space may form the L-shaped contour surrounding all objects.

Accordingly, the system 100 for recognizing space may conservatively form and output the L-shaped contour for various objects or scenarios, thereby providing accurate information required for searching for and/or controlling parking of the parking space of the vehicle 1 (also referred to as autonomous parking control).

The above-described embodiments may be implemented in the form of a recording medium for storing instructions executable by a computer. The instructions may be stored in the form of a program code, and when executed by a processor, may generate a program module to perform operations of the disclosed embodiments. The recording medium may be implemented as a computer-readable recording medium.

The computer-readable recording medium includes all types of recording media in which computer-readable instructions are stored. For example, there may be a Read Only Memory (ROM), a Random Access Memory (RAM), a magnetic tape, a magnetic disk, a flash memory, an optical data storage device, etc.

In various exemplary embodiments of the present disclosure, the memory 120 and the processor 130 may be implemented as separate semiconductor circuits. Alternatively, the memory 120 and the processor 130 may be implemented as a single integrated semiconductor circuit. The processor 130 may embody one or more processor(s).

The embodiments disclosed above have been described with reference to the accompanying drawings. It will be understood by those skilled in the art that the present disclosure may be implemented in a different form from the disclosed embodiments without changing the technical idea or essential feature of the present disclosure. The disclosed embodiments are illustrative and should not be construed as limiting.

What is claimed is:

1. A method of recognizing a free-space around a vehicle, the method comprising:
determining a corner point from cluster points of an object based on a line segment connecting a first point and a second point of the cluster points obtained by clustering Light Detection and Ranging (LiDAR) points;
determining a segment parameter according to a distance between the line segment and the corner point based on the cluster points located at both sides of the corner point; and
generating an L-shaped contour of the object based on the segment parameter to output spatial information including contour information.

2. The method according to claim 1, wherein the clustering of the LiDAR points includes:
identifying closest points which are closest to the vehicle among the LiDAR points at respective predetermined angular intervals;
identifying region of interest (ROI) points which are located within a predetermined ROI among the closest points;
determining points within a predetermined threshold distance from each other among the ROI points as the cluster points.

3. The method according to claim 2, wherein the identifying of the closest points is performed based on dividing a space in front of the vehicle into a plurality of cells by the respective predetermined angular intervals.

4. The method according to claim 2, wherein the determining of the points within the predetermined threshold distance includes removing outliers from the points within the predetermined threshold distance.

5. The method according to claim 1, wherein the determining of the corner point includes determining a point having a maximum distance from the line segment among the cluster points as the corner point.

6. The method according to claim 1, wherein the determining of the segment parameter is performed when the distance between the line segment and the corner point is greater than a predetermined threshold distance.

7. The method according to claim 6, wherein the determining of the segment parameter includes:
dividing the cluster points into two clusters each located at one of both sides of the corner point; and
determining the segment parameter through a singular value decomposition based on coordinate values of the cluster points divided into the two clusters.

8. The method according to claim 7, wherein the generating of the L-shaped contour of the object includes generating a first segment and a second segment of the L-shaped contour based on the segment parameter.

9. The method of claim 1, wherein the contour information includes position information of the first point, position information of the second point, the segment parameter, and position information of the corner point.

10. The method according to claim 6, further including generating an L-shaped contour based on maximum and minimum coordinate values of X-axis and maximum and minimum coordinate values of Y-axis among the cluster points when the distance between the line segment and the corner point is equal to or smaller than the predetermined threshold distance.

11. A free-space recognizing system comprising:
an interface configured to obtain Light Detection and Ranging (LiDAR) points from a LiDAR sensor; and
a processor connected to the interface electrically or communicatively,
wherein the processor is configured to perform:
determining a corner point from cluster points of an object based on a segment connecting a first point and a second point among the cluster points obtained by clustering the LiDAR points;
determining a segment parameter according to a distance between the segment and the corner point based on the cluster points located at both sides of the corner point; and
generating an L-shaped contour of the object based on the segment parameter to output spatial information including contour information.

12. The system of claim 11, wherein the processor is further configured to perform:
identifying closest points which are closest to the vehicle at respective predetermined angular intervals among the LiDAR points;
identifying region of interest (ROI) points in an ROI among the closest points; and
determining points within a predetermined threshold distance among the ROI points as the cluster points based on distances between the ROI points.

13. The system of claim 12, wherein the processor is further configured to perform identifying the closest points based on dividing a space in front of the vehicle into a plurality of cells by the respective predetermined angular intervals.

14. The system of claim 12, wherein the processor is further configured to perform removing outliers from the points within the predetermined threshold distance.

15. The system of claim 11, wherein the processor is further configured to perform determining a point having a maximum distance from the segment among the cluster points as the corner point.

16. The system of claim 11, wherein the processor is further configured to perform determining the segment parameter when the distance between the segment and the corner point is greater than a predetermined threshold distance.

17. The system of claim 16, wherein the processor is further configured to perform dividing the cluster points into two clusters each located at one of both sides of the corner point and determining the segment parameter through a singular value decomposition based on coordinate values of the cluster points divided into the two clusters.

18. The system of claim 17, wherein the processor is configured to perform generating a first segment and a second segment of the L-shaped contour based on the segment parameter.

19. The system of claim 11, wherein the contour information includes position information of the first point, position information of the second point, the segment parameter, and position information of the corner point of the L-shaped contour.

20. The system of claim 16, wherein the processor is further configured to perform generating an L-shaped contour based on maximum and minimum coordinate values of X-axis and maximum and minimum coordinate values of Y-axis among the cluster points when the distance between the segment and the corner point is equal to or less than the predetermined threshold distance.
